(19) United States
(12) Patent Application Publication
(10) Pub. No.: US 2026/0322192 A1
(43) Pub. Date: Oct. 15, 2026

(54) AXIAL-FLUX ELECTRIC TRACTION MACHINE

(71) Applicant: VALEO ELECTRIFICATION, Creteil Cedex (FR)

(72) Inventors: Paul ARMIROLI, Creteil Cedex (FR); Nicolas LABBE, St Quentin Fallavier (FR)

(73) Assignee: VALEO ELECTRIFICATION, Creteil Cedex (FR)

(21) Appl. No.: 19/101,132

(22) PCT Filed: Jul. 21, 2023
(86) PCT No.: PCT/EP2023/070335

§ 371 Date: Feb. 4, 2025

(30) Foreign Application Priority Data
Aug. 4, 2022 (FR) FR2208110

(51) Int. Cl. H02K 1/24; B60K 1/00; H02K 3/26

(52) U.S. Cl. CPC H02K 1/243; B60K 1/00; H02K 3/26; H02K 2203/03

(57) ABSTRACT

An axial-flux electric machine rotating about an axis of rotation and including at least one rotationally mobile homopolar rotor having p poles. The rotationally mobile homopolar rotor includes an annular disc having an axis of symmetry coincident with the axis of rotation, p/2 upper studs and p/2 lower studs, p being an even whole number, the upper studs being radially further from the axis of rotation than the lower studs, the lower and upper studs alternating circumferentially. At least one concentric rotor winding is mounted radially between the upper and lower studs and such studs not axially facing the rotor winding. The upper and lower studs are able to be polarized by a rotor current (Ir) circulating in the rotor winding to form p poles of the rotor. At least one stator, fixed in terms of rotation, includes at least one stator coil. The rotor winding is fixed in rotation.

### TECHNICAL FIELD OF THE INVENTION

The invention relates to an axial-flux rotary electric traction machine for a motor vehicle. The invention can particularly advantageously be used to drive electric vehicles of low power, in particular ranging between 4 KW and 5 kW. The invention will thus in particular possibly be advantageously implemented in low-power four-wheeled electric vehicles (microcars), in two-wheeled vehicles such as motorcycles, or in heavy ATVs. The invention also applies to powers from 100 kW to 400 kW at high voltage, for example greater than 400 V.

### Technological Background

Almost all of the known systems for the traction of electric vehicles are based on AC motors, whether synchronous AC motors with permanent magnets or asynchronous AC motors.

Drive systems for electric vehicles on the basis of a brushed DC motor or a separately excited DC motor are also known. The control of the motor essentially consists in adjusting the power on the armature (conventional mode for controlling the speed of a brushed DC motor) supplemented by varying the continuous flux on the field winding. Since such control is smooth, taking charge of it is often considered to be confusing, or even uncomfortable, by amateur dynamic drivers.

JP 2019 129638 A, CN 105 356 701 B and CN 202 856 578 U disclose axial-flux electric machine armatures comprising polyphase AC power windings where the electromechanical energy conversion takes place.

The prior art also discloses axial-flux electric machines of which the field winding and the armature face one another in the axial direction, as described in the French application 1750497 filed on Jan. 17, 2017. These axial-flux electric machines have the advantage of being axially compact. In this configuration, it is known that the rotor can be of the clawed homopolar type, as illustrated in FIG. 1. The rotor 11 described here has a single rotary rotor winding 12 irrespective of the number of poles p of the rotor. The claws, which form the various poles p of the rotor, are divided into two groups of different polarities: a first group and a second group. The two groups alternate circumferentially.

The rotor 11 in FIG. 1 comprises an annular disk 13 from which the claws extend.

Each claw of the first group, also referred to as first claw 14, has a first axial base 15 which extends from an inner periphery of the disk and a first claw tip of radially outward extent.

Each claw of the second group, also referred to as second claw 18, has a second axial base 19 which extends from an outer periphery of the disk and a second claw tip 20 of radially inward extent.

The rotary rotor winding 12 is mounted axially between the disk 13 and the claw tips 15, 20 and radially between the first bases 15 and the second bases 19.

The claws are polarized under the effect of the current circulating in the rotor winding 12 so as to form the p poles of the rotor.

Such a rotor structure with a rotary rotor winding is, however, complex to produce and mount. Steps of machining the claw tips, of mounting the rotor winding and of installing the claws make this type of field winding expensive.

Supplying power to a rotary rotor winding requires the use of friction parts, for example rings and brushes, to supply power to it. These friction parts wear out by definition and must be replaced.

### SUMMARY OF THE INVENTION

The invention aims in particular to effectively overcome the aforementioned drawbacks by proposing an axial-flux rotary electric machine rotating about an axis of rotation, characterized in that it comprises:
at least one rotationally movable homopolar rotor with p poles, comprising:
   an annular disk of axis of symmetry coincident with the axis of rotation,
   p/2 upper studs and p/2 lower studs, p being an even integer, the upper studs being radially further away from the axis of rotation than the lower studs, the lower studs and the upper studs alternating circumferentially,
at least one concentric rotor winding mounted radially between the upper studs and the lower studs, the upper studs and the lower studs not axially facing the rotor winding, the upper studs and the lower studs being able to be polarized under the effect of a rotor current circulating in the rotor winding so as to form p poles of the rotor, and
at least one rotationally fixed stator comprising at least one stator coil.

The machine is notable in that the rotor winding is rotationally fixed.

It is simpler and less expensive to manufacture and assemble the rotor in relation to the illustrated prior art. The assembly composed of the annular disk and of the studs does not have any undercut zones which make it more complex to manufacture, with in particular machining being required.

According to one aspect of the invention, there is no axial interlocking between the annular disk and the studs, for the one part, and the rotor winding, for the other part.

Since the rotor winding is kept rotationally fixed, it is no longer necessary to provide friction parts for supplying it with direct current, thereby greatly simplifying the electric machine. It is simpler to supply power to a rotationally fixed winding than to a rotationally movable winding.

The electric machine exhibits substantially identical performance properties in relation to an identical machine comprising a rotor according to FIG. 1.

The lower studs and the upper studs alternate circumferentially where a lower stud is angularly flanked by two upper studs, without taking the radial height into consideration.

Within the meaning of the invention, a disk denotes a circular or non-circular plate. A disk may for example have a polygonal contour.

According to one aspect of the invention, the rotor winding axially faces the annular disk in one of the two axial directions.

According to one aspect of the invention, the studs form the poles of the rotor when power is being supplied to the rotor winding. Each pole comprises a single stud.

According to one aspect of the invention, the lower studs extend from a radially inner periphery of the annular disk.

According to one aspect of the invention, the upper studs extend from a radially outer periphery of the annular disk.

According to one aspect of the invention, the upper studs and the lower studs form a single integral part with the annular disk. This makes it possible to reduce the number of operations during the assembly and simplifies the process. The annular disk, the upper studs and the lower studs form a one-piece part.

According to one aspect of the invention, the upper studs and the lower studs are trapezoidal. Each upper stud and each lower stud have a cylindrical radially outer surface. Each upper stud and each lower stud have a cylindrical radially inner surface.

According to one aspect of the invention, the upper studs and the lower studs do not project radially beyond the annular disk.

According to one aspect of the invention, all the upper studs and all the lower studs associated with said rotor winding are on the same axial side of the annular disk.

According to one aspect of the invention, at least one of the upper studs and lower studs may have an insert which accommodates a magnet. The magnet makes it possible to increase the rotor field strength. The insert may be blind, in particular in the radial direction, in particular in the axial direction, in particular in the axial direction and the axial direction.

According to one aspect of the invention, all the upper studs and all the lower studs have a magnet.

According to one aspect of the invention, p ranges between two and thirty two, in particular between four and sixteen. The rotor has a pole pitch equal to 2*π/p, expressed in radians.

According to one aspect of the invention, the lower studs are capable of all exhibiting the same polarity and the upper studs are all capable of all exhibiting the same polarity, which is the opposite polarity to that of the lower studs.

All the lower studs may have the same shape. All the lower studs may be distributed evenly in the circumferential direction.

According to one aspect of the invention, each lower stud has an outer angular opening. The value of the outer angular opening of the lower studs β1 may range between 0.5*(pole pitch) and 0.95*(pole pitch).

According to one aspect of the invention, each lower stud has an inner angular opening. The value of the inner angular opening of the lower studs β2 may range between 0.5*(pole pitch) and 0.95*(pole pitch). For the lower studs, the outer angular opening may be larger than or identical to the inner angular opening. The lower studs may widen radially to the outside.

All the upper studs may have the same shape. All the upper studs may be distributed evenly in the circumferential direction.

According to one aspect of the invention, each upper stud has an outer angular opening. The value of the outer angular opening of the upper studs β3 may range between 0.5*(pole pitch) and 0.95*(pole pitch).

According to one aspect of the invention, each upper stud has an inner angular opening. The value of the inner angular opening of the upper studs β4 may range between 0.5*(pole pitch) and 0.95*(pole pitch). For the upper studs, the inner angular opening may be larger than or identical to the upper angular opening. The upper studs may widen radially to the inside.

According to one aspect of the invention, the annular disk may be hollow.

According to one aspect of the invention, the annular disk is mounted on a rotor shaft. The annular disk is for example pushed on or shrink-fitted.

According to one aspect of the invention, the annular disk has an outer radius. The value of the outer radius Rext may range between 10 cm and 40 cm, preferably between 10 cm and 20 cm, in particular 15 cm.

According to one aspect of the invention, the annular disk has an inner radius. The value of the inner radius Rint may range between 0.1*Rext and 0.75*Rext, in particular between 0.4*Rext and 0.60*Rext, for example 0.5*Rext.

According to one aspect of the invention, the radially outer surfaces of the upper studs are contiguous with the radially outer surface of the annular disk.

According to one aspect of the invention, the radially inner surfaces of the lower studs are contiguous with the radially inner surface of the annular disk.

According to one aspect of the invention, the rotor has a rotor axial dimension with a value Lz that can range between 2 cm and 10 cm, in particular between 3 cm and 5 cm, for example 3.6 cm. The annular disk has an axial thickness. The value of the axial thickness of the annular disk ez1 may range between 0.25*Lz and 0.4*Lz.

According to one aspect of the invention, each upper stud and each lower stud has an axial dimension. This axial dimension may be identical for each of the upper studs and each of the lower studs. The value of this axial dimension ez2 may range between 0.5*Lz and 0.75*Lz.

According to one aspect of the invention, the electric machine has an upper radial gap between the upper studs and the rotor winding of between 0.1 mm and 1 mm.

According to one aspect of the invention, the electric machine has a lower radial gap between the lower studs and the rotor winding of between 0.1 mm and 1 mm.

According to one aspect of the invention, the electric machine has an axial gap between the rotor winding and the annular disk. The radial gap may range between 0.1 mm and 1 mm.

According to one aspect of the invention, the rotor winding is mounted on the stator. The fixed portions of the machine are thus pooled, thereby avoiding the need to provide a fixed part dedicated to the rotor winding.

According to one aspect of the invention, the electric machine comprises a single rotor winding.

According to one aspect of the invention, the electric machine may comprise a plurality of rotor windings supplied with power in parallel.

According to one aspect of the invention, the electric machine comprises a casing. The rotor winding is supported by a rotor disk, and the rotor disk and the stator are fixed to the casing.

According to one aspect of the invention, the rotor disk is a part independent of the stator. The rotor disk may be non-magnetic.

According to one aspect of the invention, the stator comprises a printed circuit board (PCB). The printed circuit board may comprise at least one PCB layer comprising the stator coil.

According to one aspect of the invention, the printed circuit board (PCB) may comprise a plurality of PCB layers.

According to one aspect of the invention, each PCB layer has a plurality of stator coils. These stator coils may be coplanar and angularly and symmetrically spaced apart from one another.

According to one aspect of the invention, each stator coil is continuous and concentric in a single plane from an outermost stator coil portion to a concentric innermost stator coil portion.

According to one aspect of the invention, the stator coils in adjacent PCB layers are circumferentially aligned with one another with respect to the axis to define symmetrical stacks of stator coils in an axial direction.

According to one aspect of the invention, each stator coil includes a first terminal on the outer edge of the coil, and a second terminal in the center of the stator coil.

According to one aspect of the invention, each stator coil may be connected directly to an adjacent stator coil on the same PCB layer. Each stator coil may be connected directly to a corresponding stator coil on another PCB layer.

According to one aspect of the invention, each stator coil has only two terminals, each coil being continuous and uninterrupted between its only two terminals.

According to one aspect of the invention, the rotor winding is fixed to, for example overmolded on, the printed circuit board.

According to one aspect of the invention, the stator comprises a plurality of teeth, the stator coil being wound around said teeth.

According to one aspect of the invention, the stator comprises a plurality of stator coils, each being wound on one of said teeth.

According to one aspect of the invention, the rotor winding carries the direct rotor current, and in that the at least one stator coil carries a polyphase stator current system.

The rotor current does not change sign and serves mainly to establish the level of flux. It will be noted that the rotor winding does not carry a polyphase current system during normal operation.

According to one aspect of the invention, the rotor winding is electrically connected to a control device. The control device may comprise a plurality of controllable switches in order to continuously vary the current in the winding. The switches may be MOSFETs and/or diodes. The controllable switches may be disposed in an H-bridge.

According to one aspect of the invention, each rotor is axially flanked by two stators. The rotor may comprise p/2 upper studs and p/2 lower studs on each of the two axial sides of the annular disk.

According to one aspect of the invention, each rotor may be associated with two rotor windings, each rotor winding being associated with one axial side of the annular disk.

According to one aspect of the invention, each stator is axially flanked by two rotors. The two rotors may be associated with the same stator.

According to one aspect of the invention, the electric machine may have a mechanical nominal power of between 4 kW and 35 KW, being for example 4 kW, 8 KW, 15 KW, 25 KW or 35 kW, or the electric machine may have a nominal mechanical power of between 40 KW and 400 kW, being for example 40 KW, 80 KW, 100 KW, 150 KW, 180 KW, 200 kW, 300 kW or 400 kW.

This rotary electric machine can be electrically powered from an electrical energy storage unit via an inverter/rectifier that allows an electrical system of the vehicle to be charged or that can be powered from this system, depending on whether the rotary electric machine is operating as a motor or as a generator.

The nominal voltage of the electrical energy storage unit can be 12 V, 48 V or have another value, for example another value greater than 300 V.

The invention also relates to a motor vehicle, characterized in that it comprises a rotary electric machine as defined above for driving said vehicle.

According to one embodiment, the electric traction machine is installed on a rear axle between a wheel and a differential of said motor vehicle. In a variant, the electric machine could be installed directly in the wheel of the vehicle in a “wheel motor” type mounting.

According to one aspect of the invention, the motor vehicle may be a vehicle with purely electric traction. According to one aspect of the invention, the vehicle may be a vehicle with hybrid, i.e. both thermal and electric, traction.

According to one aspect of the invention, the motor vehicle may be an electric utility vehicle or a light truck. The electric machine according to the invention, which is of the axial type, makes it possible to obtain a greater specific power and greater continuous output than the electric machines according to the prior art. This electric machine is designed for driving profiles of utility vehicles that transport loads and require continuous electric power.

### BRIEF DESCRIPTION OF THE FIGURES

The invention will be understood better from reading the following description and examining the accompanying figures. These figures are provided only by way of entirely nonlimiting illustration of the invention.

Identical, similar or analogous elements retain the same references from one figure to another.

FIG. 1 is a perspective view of an example of a rotor according to the prior art.

FIG. 2 is a schematic view of an example of a motor vehicle according to the present invention.

FIG. 3 is an exploded perspective view of an example of an electric machine according to the invention.

FIG. 4 is a perspective view of a rotor of the electric machine in FIG. 3.

FIG. 5 is a front view of the rotor and the rotor winding in FIG. 3.

FIG. 6 is a front view of an example of a stator of the electric machine according to the invention.

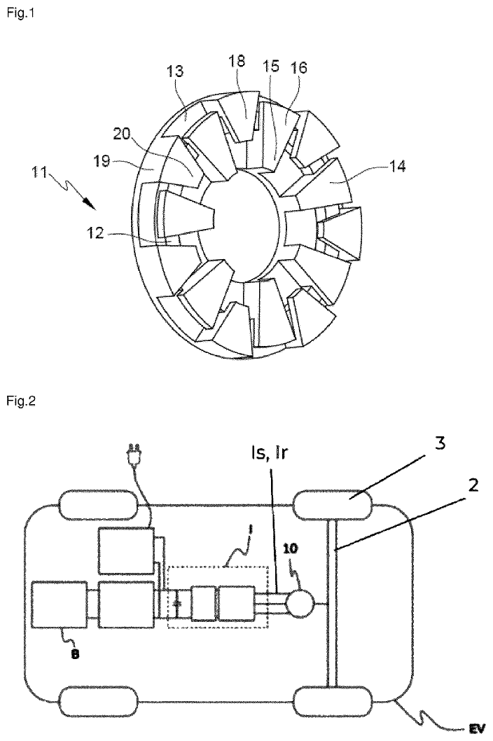

### DETAILED DESCRIPTION OF THE INVENTION

FIG. 2 illustrates a motor vehicle according to one example of the invention, comprising a rotary electric machine 10 according to one example of the invention.

In the example in question, the motor vehicle is an electric vehicle EV comprising wheels 3 and the electric machine 10. The electric machine is configured to at least indirectly drive at least one of the wheels 3. The vehicle comprises a high-voltage supply battery B, preferably a rechargeable battery, for providing the machine with electrical energy. The battery B is for example a high-voltage, in particular greater than 60 V, supply battery. The battery may also be a low-voltage, in particular 48 V, battery.

In the example in question, the electric machine 10 makes it possible to move the vehicle EV by itself and is installed on a rear axle 2 between a rear wheel 3 and a differential. In a variant, the electric machine 10 may be installed on the front axle, which is not shown. In a further variant, the electric machine 10 may be installed in at least one wheel 3. Use is made in particular of one electric machine 10 in each rear wheel 3.

In the example described, the electric machine 10 comprises at least one rotor, at least one rotor winding and at least one stator. They will be described in more detail in connection with the following figures.

In the example described, the stator is supplied with power via an inverter/rectifier I configured to convert a direct current (DC) from the battery B into an alternating current (AC) in order to control the electric machine 10. The stator carries a polyphase, in particular three-phase, stator current system Is.

In the example in question, the rotor winding is also supplied with power by the battery B via a direct rotor current Ir. The rotor winding is electrically connected to the battery B.

In the example in question, the rotor winding is able to continuously generate a rotor current from zero to a maximum value in order to vary the rotor flux.

In the example in question, the rotor current Ir is independent of the stator current Is.

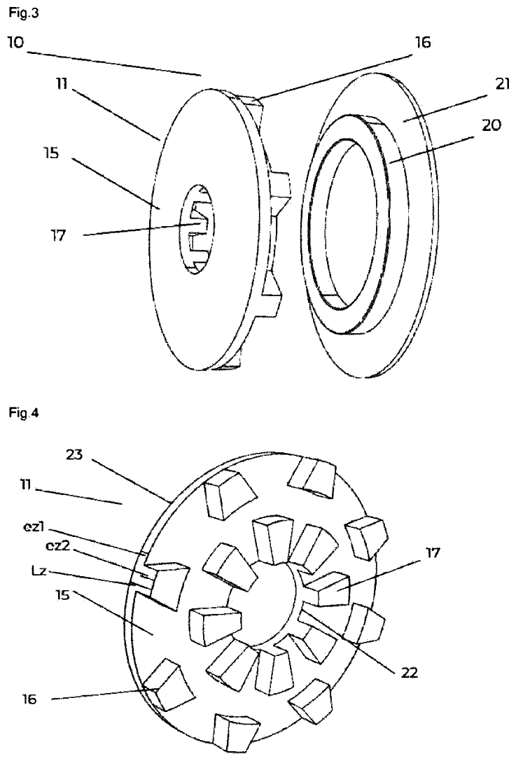

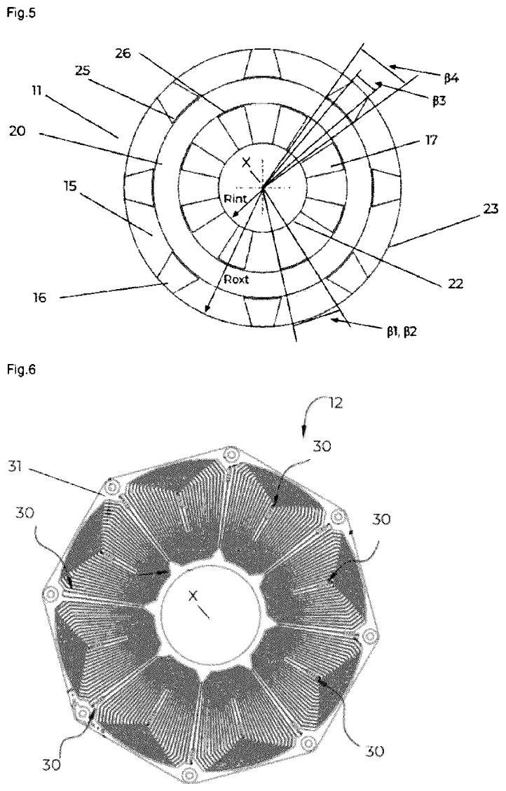

FIG. 3 now describes in detail an example of an axial-flux machine 10 according to the invention, which can be fitted to the vehicle described in FIG. 2. The electric machine is an axial-flux electric machine rotating about an axis X of rotation.

In the example in question, the rotor 11 is homopolar, is rotationally movable and has p poles. The rotor 11 comprises an annular disk 15 of axis of symmetry coincident with the axis X.

In the example in question, the rotor 11 also comprises p/2 upper studs 16 and p/2 lower studs 17. The upper studs 16 are radially further away from the axis X than the lower studs 17.

The lower studs 17 and the upper studs 16 alternate circumferentially. Each lower stud 17 is angularly flanked by two upper studs 16, without taking the radial height into consideration.

P is an even integer. P ranges between two and thirty two. It is sixteen in this case. The rotor 11 has a pole pitch equal to 2*Pi/p, either for π/8 radians for a polarity of 8, or . 0.22.5 degrees.

In the example in question, the electric machine 10 comprises at least one concentric rotor winding 20 mounted radially between the upper studs 16 and the lower studs 17. The upper studs 16 and the lower studs 17 do not axially face the rotor winding 20.

In the example in question, the upper studs 16 and the lower studs 17 are polarized under the effect of the rotor current Ir flowing in the rotor winding 20 so as to form the sixteen poles of the rotor 11. The lower studs 17 all exhibit the same polarity and the upper studs 16 all exhibit the same polarity, which is the opposite polarity to that of the lower studs 17.

Each of the sixteen poles of the electric machine 10 comprises a single stud from among the upper studs 16 and the lower studs 17.

In the example in question, the rotor winding 20 is rotationally fixed. The rotor winding 20 is supported by a rotor disk 21, which is itself rotationally fixed and is a part independent of the stator.

In a variant which is not shown, the rotor winding is mounted on the stator. There is no rotor disk dedicated to the fixing of the rotor winding.

In the example in question, there is a single rotor winding 20.

In the example in question, there is no axial interlocking between the annular disk and the studs, for the one part, and the rotor winding, for the other part. The rotor winding 20 axially faces the annular disk 15 in one of the two axial directions, i.e. along the axis X. All the upper studs 16 and all the lower studs 17 associated with the rotor winding are on the same axial side of the annular disk 15.

In the example in question, the lower studs 17 extend from a radially inner periphery 22 of the annular disk 15 and the upper studs 16 extend from a radially outer periphery 23 of the annular disk 15. The upper studs 16 and the lower studs 17 do not project radially beyond the annular disk.

In the example in question, the upper studs 16 and the lower studs 17 are formed integrally with the annular disk 15. The annular disk 15, the upper studs 16 and the lower studs 17 thus form a one-piece part.

In the example in question, the upper studs 16 and the lower studs 17 are all trapezoidal. Each upper stud 16 and each lower stud 17 have a cylindrical radially outer surface and a cylindrical radially inner surface. The radially outer surfaces of the upper studs 16 are contiguous with the radially outer surface of the annular disk 15 and the radially inner surfaces of the lower studs 17 are contiguous with the radially inner surface of the annular disk 15.

In the example in question, all the lower studs 17 have the same shape and are evenly distributed in the circumferential direction. Each lower stud 17 has an outer angular opening β1 with a value of between 0.5*(pole pitch) and 0.95*(pole pitch) and an inner angular opening β2 with a value of between 0.5*(pole pitch) and 0.95*(pole pitch). In this case, β1 and β2 are equal.

In the example in question, all the upper studs 16 have the same shape and are evenly distributed in the circumferential direction. Each upper stud 16 has an outer angular opening β3 with a value of between 0.5*(pole pitch) and 0.95*(pole pitch) and an inner angular opening β4 with a value of between 0.5*(pole pitch) and 0.95*(pole pitch). In this case, β4 is greater than β2. The upper studs widen radially to the inside.

In the example in question, the annular disk 15 is hollow. The annular disk is mounted, for example pushed or shrink-fitted, on a rotor shaft, which is not shown.

In the example in question, the annular disk has an outer radius Rext with a value of between 10 cm and 40 cm, preferably between 10 cm and 20 cm, in particular 15 cm and an inner radius Rint with a value of between 0.1*Rext and 0.75*Rext, in particular between 0.4*Rext and 0.60*Rext, for example 0.5*Rext.

In the example in question, the rotor 11 has a rotor axial dimension with a value Lz that can range between 2 cm and 10 cm, in particular between 3 cm and 5 cm, for example 3.6 cm. The annular disk 15 also has an axial thickness ez1 with a value of between 0.25*Lz and 0.4*Lz.

In the example in question, each upper stud 16 and each lower stud 17 has an identical axial dimension ez2 with a value of between 0.5*Lz and 0.75*Lz.

In the example in question, the electric machine 10 has an upper radial gap 25 between the upper studs 16 and the rotor winding 20 of between 0.1 mm and 1 mm.

In the example in question, the electric machine 10 has a lower radial gap 26 between the lower studs 17 and the rotor winding 20 of between 0.1 mm and 1 mm.

In the example in question, the electric machine has an axial gap of between 0.1 mm and 1 mm between the rotor winding and the annular disk.

In the example in question, the rotor disk 21 and the stator may be fixed to a casing of the electric machine 10. An example of a stator 12 will be described with reference to FIG. 6.

In the example in question, the stator 12 is rotationally fixed and comprises a plurality of stator coils 30 and a printed circuit board or PCB 31. The printed circuit board may comprise a plurality of PCB layers. Each PCB layer has a plurality of coplanar stator coils 30 angularly and symmetrically spaced apart from one another.

In the example in question, each stator coil 30 is continuous and concentric in a single plane from an outermost stator coil portion to a concentric innermost stator coil portion.

In the example in question, the stator coils in adjacent PCB layers are circumferentially aligned with one another with respect to the axis to define symmetrical stacks of stator coils in an axial direction.

In the example in question, each stator coil 30 is connected directly to an adjacent stator coil on the same PCB layer.

In an example which is not shown, the rotor winding 20 may be mounted on the stator 12. The rotor winding may be overmolded or welded on the printed circuit board 31. In such a variant, the electric machine 10 does not have a rotor disk.

According to a variant which is not shown, the stator comprises a plurality of coils, each being wound on one of said teeth.

In an example which is not shown, the machine may comprise a single stator 12 surrounded by two rotors 11.

In an example which is not shown, the electric machine 10 comprises a plurality of rotors 11, each rotor 11 being axially flanked by two stators 12. The rotors 11 may then comprise the upper studs 16 and the lower studs 17 on each of the two axial sides of the annular disk 15. Each rotor 11 may be associated with two rotor windings 20, each rotor winding being associated with one axial side of the annular disk.

Of course, the above description has been given only by way of example and does not limit the field of the invention, which would not be departed from by replacing the various elements with any other equivalents.

Identical, similar or analogous elements retain the same references from one figure to another.

1. An axial-flux rotary electric machine rotating about an axis of rotation, comprising:
at least one rotationally movable homopolar rotor with p poles, comprising:
an annular disk of axis of symmetry coincident with the axis of rotation,
p/2 upper studs and p/2 lower studs, p being an even integer, the upper studs being radially further away from the axis of rotation than the lower studs, the lower studs and the upper studs alternating circumferentially,
at least one concentric rotor winding mounted radially between the upper studs and the lower studs, the upper studs and the lower studs not axially facing the rotor winding, the upper studs and the lower studs being able to be polarized under the effect of a rotor current circulating in the rotor winding so as to form p poles of the rotor, and
at least one rotationally fixed stator comprising at least one stator coil, wherein the rotor winding is rotationally fixed.

2. The electric machine as claimed in claim 1, wherein the lower studs extend from the radially inner periphery of the annular disk and in that the upper studs extend from a radially outer periphery of the annular disk.

3. The electric machine as claimed in claim 1, the electric machine having an upper radial gap between the upper studs and the rotor winding of between 0.1 mm and 1 mm and a lower radial gap between the lower studs and the rotor winding of between 0.1 mm and 1 mm.

4. The electric machine as claimed in claim 1, wherein the rotor winding is mounted on the stator.

5. The electric machine as claimed in claim 1, wherein the electric machine comprises a casing, the rotor winding is supported by a rotor disk, the rotor disk and the stator being fixed to the casing.

6. The electric machine as claimed in claim 1, the stator comprising a printed circuit board or PCB, the printed circuit board comprising at least one PCB layer comprising said stator coil.

7. The electric machine as claimed in claim 1, the stator comprising a plurality of teeth, the stator coil being wound around said teeth.

8. The electric machine, wherein the rotor winding carries the direct rotor current, and in that the at least one stator coil carries a polyphase current system.

9. A motor vehicle wherein it comprises an electric machine as defined in claim 1 for driving said vehicle.

10. The motor vehicle as claimed claim 9, wherein the electric machine is installed on a rear axle between a wheel and a differential of said motor vehicle.

11. The electric machine as claimed in claim 2, the electric machine having an upper radial gap between the upper studs and the rotor winding of between 0.1 mm and 1 mm and a lower radial gap between the lower studs and the rotor winding of between 0.1 mm and 1 mm.

12. The electric machine as claimed in claim 2, wherein the rotor winding is mounted on the stator.

13. The electric machine as claimed in claim 2, wherein the electric machine comprises a casing, the rotor winding is supported by a rotor disk, the rotor disk and the stator being fixed to the casing.

14. The electric machine as claimed in claim 2, the stator comprising a printed circuit board or PCB, the printed circuit board comprising at least one PCB layer comprising said stator coil.

15. The electric machine as claimed in claim 2, the stator comprising a plurality of teeth, the stator coil being wound around said teeth.

16. A motor vehicle wherein it comprises an electric machine as defined in claim 2 for driving said vehicle.

17. The electric machine as claimed in claim 3, wherein the rotor winding is mounted on the stator.

18. The electric machine as claimed in claim 3, wherein the electric machine comprises a casing, the rotor winding is supported by a rotor disk, the rotor disk and the stator being fixed to the casing.

19. The electric machine as claimed in claim 3, the stator comprising a printed circuit board or PCB, the printed circuit board comprising at least one PCB layer comprising said stator coil.

20. The electric machine as claimed in claim 3, the stator comprising a plurality of teeth, the stator coil being wound around said teeth.
